(19) United States
(12) Patent Application Publication
(10) Pub. No.: US 2026/0352429 A1
(43) Pub. Date: Nov. 5, 2026

(54) COMMUNICATION METHOD AND APPARATUS, AND DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/120,369

(22) PCT Filed: Oct. 13, 2022
(86) PCT No.: PCT/CN2022/125194

§ 371 Date: Apr. 11, 2025

(51) Int. Cl. H04L 5/00; H04L 43/062

(52) U.S. Cl. CPC H04L 5/0098; H04L 43/062

(57) ABSTRACT

The embodiments of the present disclosure relate to the technical field of communications. Provided are a communication method and apparatus, and a device and a storage medium, which can be applied to an access point (AP) device. The method comprises: determining a first message frame, wherein the first message frame comprises first identification information, and the first identification information is used for indicating that a neighbor AP device supports communication in at least one frequency band of a 45 GHz frequency band and a 60 GHz frequency band; and sending the first message frame. By means of the embodiments of the present disclosure, a communication mode indicating that a neighbor AP device supports communication in a 45 GHz frequency band and/or a 60 GHz frequency band can be provided.

### CROSS-REFERENCE TO RELATED APPLICATION

The application is a U.S. National Stage of International Application No. PCT/CN2022/125194 filed on Oct. 13, 2022, the entire content of which is incorporated herein by reference.

### TECHNICAL FIELD

Embodiments of the present disclosure relate to the technical field of communication, and in particular, the embodiments of the present disclosure relate to a communication method and apparatus, a device, and a storage medium.

### BACKGROUND

With the continuous development of Wireless Fidelity (Wi-Fi) technology, researchers have proposed the next-generation Wi-Fi technology: the Ultra High Reliability (UHR). Its vision is to improve the reliability of WLAN connections, reduce latency, improve manageability, increase system throughput, and reduce the power consumption of the corresponding device.

### SUMMARY

In a first aspect, an embodiment of the present disclosure provides a communication method, which may be applied to an access point (AP) device, and the method includes:
determining a first message frame, where the first message frame includes first identification information, and the first identification information is used to indicate that a neighbor AP device supports communicating in at least one frequency band of a 45 GHZ frequency band or a 60 GHz frequency band; and sending the above first message frame.

In a second aspect, an embodiment of the present disclosure provides a communication method, which may be applied to a station (STA) device, and the method includes:
receiving a first message frame, where the first message frame includes first identification information, and the first identification information is used to indicate that a neighbor AP device supports communicating in at least one frequency band of a 45 GHZ frequency band or a 60 GHz frequency band.

In a third aspect, an embodiment of the present disclosure further provides a communication apparatus, which includes:
a determining unit, configured to determine a first message frame, where the first message frame includes first identification information, and the first identification information is used to indicate that a neighbor AP device supports communicating in at least one frequency band of a 45 GHz frequency band or a 60 GHz frequency band; and a sending unit, configured to send the above first message frame.

In a fourth aspect, an embodiment of the present disclosure further provides a communication apparatus, which includes:
a receiving unit, configured to receive a first message frame, where the first message frame includes first identification information, and the first identification information is used to indicate that a neighbor AP device supports communicating in at least one frequency band of a 45 GHz frequency band or a 60 GHz frequency band.

In a fifth aspect, an embodiment of the present disclosure further provides an access point (AP) device, including a memory, a processor, and a computer program stored on the memory and executable on the processor, and the processor, when executing the program, implements the communication method provided in the first aspect of the embodiments of the present disclosure.

In a sixth aspect, an embodiment of the present disclosure further provides a station (STA) device, including a memory, a processor, and a computer program stored on the memory and executable on the processor, and the processor, when executing the program, implements the communication method provided in the second aspect of the embodiment of the present disclosure.

In a seventh aspect, an embodiment of the present disclosure further provides a computer-readable storage medium on which a computer program is stored, and when executed by a processor, the computer program implements any of the communication methods provided in the embodiments of the present disclosure.

Additional aspects and advantages of the embodiments of the present disclosure will be partially provided in the description below, which will become apparent from the description below, or will be learned through the practice of the present disclosure.

### BRIEF DESCRIPTION OF THE DRAWINGS

In order to more clearly illustrate the technical solutions of the embodiments of the present disclosure, the drawings that are to be used in the description of the embodiments of the present disclosure will be briefly introduced below. Obviously, the drawings in the following description are only some embodiments of the present disclosure, and those of ordinary skill in the art may obtain other drawings based on these drawings without paying creative effort.

FIG. 1 is a schematic flowchart of a communication method provided by an embodiment of the present disclosure;

FIG. 2 is another schematic flowchart of a communication method provided by an embodiment of the present disclosure;

FIG. 3 is a schematic structural diagram of a communication apparatus provided by an embodiment of the present disclosure;

FIG. 4 is another schematic structural diagram of a communication apparatus provided by an embodiment of the present disclosure; and

FIG. 5 is a schematic structural diagram of an electronic device provided by an embodiment of the present disclosure.

### DETAILED DESCRIPTION

In the embodiments of the present disclosure, the term “and/or” describes association relationship of associated objects, indicating that there may be three types of relationships. For example, A and/or B may indicate three cases where A exists alone, A and B exist at the same time, and B exists alone. The character “/” generally indicates that the related objects before and after this character are in an “or” relationship.

The term “a plurality of” in the embodiments of the present disclosure refers to two or more than two, and other quantifiers are similar thereto.

The exemplary embodiments will be described in detail herein, examples of which are shown in the accompanying drawings. When the drawings are involved in the following description, the same numbers in different drawings represent the same or similar elements, unless otherwise indicated. The embodiments described in the following illustrative embodiments do not represent all embodiments consistent with the present disclosure. Instead, they are merely examples of apparatuses and methods consistent with some of aspects of the present disclosure as detailed in the appended claims.

The terms used in the present disclosure are for the purpose of describing specific embodiments only and are not intended to restrict the present disclosure. The singular forms of “a”, “said” and “the” used in the present disclosure and the appended claims are also intended to include plural forms unless the context clearly indicates otherwise. It should also be understood that the term “and/or” used herein refers to and includes any or all possible combinations of one or more associated items listed.

It should be understood that although the terms of first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the wording “if’ used herein may be interpreted as “at the time of . . . ” or “when . . . ” or “in response to determining”.

A clear and complete description of technical solutions in the embodiments of the present disclosure will be provided below with reference to the drawings in the embodiments of the present disclosure. Obviously, the described embodiments are only a part of the embodiments of the present disclosure, but not all of the embodiments. Based on the embodiments in the present disclosure, all other embodiments obtained by those of ordinary skill in the art without paying creative effort fall within the protection scope of the present disclosure.

The method and the apparatus are based on the same disclosed concept. Since the principles for the method and apparatus to solve the problem are similar, the implementations of the apparatus and the method may be referred to each other, and the repeated parts will not be repeated.

The AP device is a wireless switch used for a wireless network and also an access device of the wireless network. The AP device may include software applications and/or circuits, enabling other types of nodes in the wireless network to communicate with the outside and inside of the wireless network through the AP. As an example, an AP device may be a terminal device or a network device equipped with a Wi-Fi chip.

The STA device may include, but is not limited to: a cellular phone, a smartphone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

In the existing standards, in order to identify capability information of a neighbor access point (AP) device, the AP device may send a neighbor report information element to a station (STA) device. The neighbor report information element includes the capability information supported by the neighbor AP device, such as the capabilities of supporting High Efficiency (HE), Extreme High Efficiency (EHT), etc. However, there is currently no conclusion on how to indicate a communication frequency band supported by the neighbor AP in the next-generation UHR standard.

The embodiments of the present disclosure provide a communication method and apparatus, a device, and a storage medium, which may provide a communication mode for indicating that a neighbor AP device supports communicating in a 45 GHz frequency band and/or a 60 GHz frequency band.

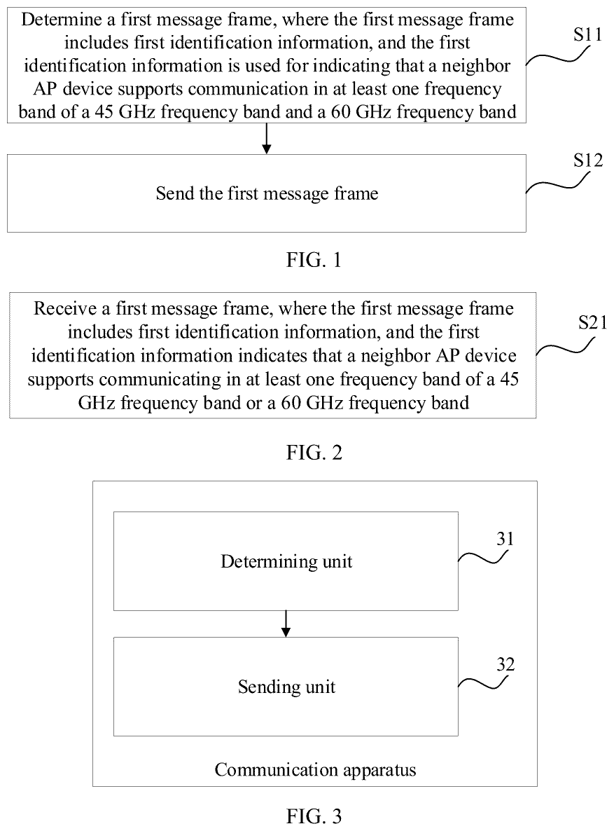

A communication method provided by an embodiment of the present disclosure may be specifically referred to FIG. 1, which is a schematic flowchart of the communication method provided by the embodiment of the present disclosure.

In some embodiments, the method may be applied to an AP device. The method may include the following steps.

In step S11, the first message frame is determined, where the first message frame includes first identification information, and the first identification information is used to indicate that a neighbor AP device supports communicating in at least one frequency band of a 45 GHz frequency band or a 60 GHz frequency band.

The first identification information may specifically indicate, through at least one bit, that the neighbor AP device supports communicating in at least one of the 45 GHZ frequency band or the 60 GHz frequency band. The first identification information may indicate that the neighbor AP supports communicating in both the 45 GHz frequency band and the 60 GHz frequency band by indicating “Co-located with 45 GHz/60 GHZ AP”.

As an example, the first identification information may include one bit, and when the value of this bit is 1, it indicates that the neighbor AP device supports communicating in both the 45 GHz frequency band and the 60 GHz frequency band.

As an example, the first identification information may include a first bit and/or a second bit. When the value of the first bit is 1, it indicates that the neighbor AP device supports communicating in the 45 GHz frequency band. When the value of the second bit is 1, it indicates that the neighbor AP supports communicating in the 60 GHz frequency band.

In step S12, the first message frame is sent.

After the first message frame is determined, the first message frame is sent to the station (STA) device.

In the communication method applied to an access point (AP) device provided by the present disclosure, the first message frame includes a neighbor report information element (Neighbor Report Element), and the neighbor report information element includes first identification information.

That is, the AP device may indicate that the neighbor AP device supports communication in at least one of the 45 GHz frequency band or the 60 GHz frequency band by sending the first message frame that includes the neighbor report information element. Specifically, this indication may be made through the first identification information in the neighbor report information element.

In the communication method applied to an access point (AP) device provided by the present disclosure, the neighbor report information element includes a basic service set (BSS) identifier (ID) information field, and the basic service set identifier information field includes the first identification information.

That is, the AP device may indicate that the neighbor AP device supports communication in at least one of the 45 GHz frequency band or the 60 GHz frequency band by sending the first message frame that includes the neighbor report information element. Specifically, this indication may be made through the first identification information within the basic service set identifier (BSSID) information field included in the neighbor report information element.

As an example, the first identification information may be at least one bit in the reserved bits in the basic service set identifier information field.

In the communication method applied to the access point (AP) device provided by the present disclosure, the first identification information is further used to indicate that the neighbor AP supports the ultra high reliability (UHR) capability.

When the first identification information is used to indicate that the neighbor AP device supports the UHR capability, the neighbor AP device supports communication in the sub-7 GHz frequency band.

As an example, the first message frame includes first identification information, which may be used to indicate that the neighbor AP simultaneously supports communicating in the sub-7 GHZ, 45 GHZ, and 60 GHz frequency bands.

In the communication method applied to the access point (AP) device provided by the present disclosure, the neighbor report information element includes a first information element. When the first identification information is used to indicate that the neighbor AP device supports communicating in the 45 GHz frequency band or 60 GHz frequency band, the first information element includes at least one of bandwidth (BW) information, number of spatial stream (NSS), or a modulation and coding scheme (MCS) corresponding to the neighbor AP device when communicating in the 45 GHz frequency band or 60 GHz frequency band.

Specifically, when the first identification information is used to indicate that the neighbor AP device supports communicating in the 45 GHz frequency band, the first information element includes at least one of the bandwidth information, the number of spatial streams, or the modulation and coding scheme corresponding to the neighbor AP device when communicating in the 45 GHz frequency band.

As an example, the neighbor report information element includes a first information element. When the first identification information is used to indicate that the neighbor AP device supports communicating in the 45 GHz frequency band, the first information element includes the bandwidth information corresponding to the neighbor AP device when communicating in the 45 GHz frequency band.

As an example, the neighbor report information element includes a first information element. When the first identification information is used to indicate that the neighbor AP device supports communicating in the 45 GHz frequency band, the first information element includes the number of spatial streams corresponding to the neighbor AP device when communicating in the 45 GHz frequency band, such as the maximum number of spatial streams supported.

As an example, the neighbor report information element includes a first information element. When the first identification information is used to indicate that the neighbor AP device supports communicating in the 45 GHz frequency band, the first information element includes the modulation and coding scheme corresponding to the neighbor AP device when communicating in the 45 GHz frequency band.

Specifically, when the first identification information is used to indicate that the neighbor AP device supports communicating in the 60 GHz frequency band, the first information element includes at least one of the bandwidth information, the number of spatial streams, or the modulation and coding scheme corresponding to the neighbor AP device when communicating in the 60 GHz frequency band.

As an example, the neighbor report information element includes a first information element. When the first identification information is used to indicate that the neighbor AP device supports communicating in the 60 GHz frequency band, the first information element includes the bandwidth information corresponding to the neighbor AP device when communicating in the 60 GHz frequency band.

As an example, the neighbor report information element includes a first information element. When the first identification information is used to indicate that the neighbor AP device supports communicating in the 60 GHz frequency band, the first information element includes the number of spatial streams corresponding to the neighbor AP device when communicating in the 60 GHz frequency band, such as the maximum number of spatial streams supported.

As an example, the neighbor report information element includes a first information element. When the first identification information is used to indicate that the neighbor AP device supports communicating in the 60 GHz frequency band, the first information element includes the modulation and coding scheme corresponding to the neighbor AP device when communicating in the 60 GHz frequency band.

In the communication method applied to the access point (AP) device provided by the present disclosure, the neighbor report information element includes a first information element. When first identification information is used to indicate that a neighbor AP device supports the ultra-high reliability (UHR) capability, the first information element includes at least one of bandwidth information or packet extension (PE) information corresponding to the neighbor AP device when communicating in the sub-7 GHz frequency band.

As an example, the neighbor report information element includes a first information element. When the first identification information is used to indicate that the neighbor AP device supports the ultra-high reliability (UHR) capability, the first information element includes the bandwidth information corresponding to the neighbor AP device communicating in the sub-7 GHz frequency band.

The bandwidth information corresponding to the communication of the neighbor AP device in the sub-7 GHz frequency band may be 640 MHz or 320 MHz+160 MHz, etc., which is not limited herein.

As an example, the neighbor report information element includes a first information element. When the first identification information is used to indicate that the neighbor AP device supports the ultra-high reliability (UHR) capability, the first information element includes the packet extension information corresponding to the neighbor AP device when communicating in the sub-7 GHz frequency band.

In some embodiments, when the first identification information is used to indicate that the neighbor AP device supports the ultra high reliability (UHR) capability, the first information element may further include at least one of the number of spatial streams or the modulation and coding scheme corresponding to the neighbor AP device when communicating in the sub-7 GHz frequency band.

In the communication method applied to an access point (AP) device provided by the present disclosure, when the neighbor report information element includes a first information element, the first information element is at least one of a capability information element (Capabilities Element) or an operational information element (Operational Element).

The content of the first information element is the same as the content of the capability information element or the operation information element in a beacon frame or a probe response frame sent by the AP device in the same basic service set.

In the communication method applied to the access point (AP) device provided by the present disclosure, the neighbor report information element further indicates, through other identification information, that the neighbor AP device supports communicating in the 5 GHz frequency band and/or 6 GHz frequency band.

As an example, the neighbor report information element includes second identification information and third identification information. When the values of the second identification information and third identification information are 1, it indicates that the neighbor AP device supports communicating in both the 5 GHz frequency band and the 6 GHZ frequency band.

As an example, when the values of the first identification information, second identification information, and third identification information are 1, it indicates that the neighbor AP device simultaneously supports communicating in the 5 GHz frequency band, 6 GHz frequency band, 45 GHz frequency band, and 60 GHz frequency band.

In the communication method applied to an access point (AP) device provided by the present disclosure, the first message frame is a neighbor report request frame.

As an example, the AP device sends a neighbor report request frame, which includes first identification information. This first identification information is used to indicate that the neighbor AP device supports communicating in at least one of the 45 GHz frequency band or the 60 GHz frequency band.

In some embodiments, the neighbor report request frame includes a neighbor report information element, which includes first identification information. The first identification information is used to indicate that the neighbor AP device supports communicating in at least one of the 45 GHz frequency band or the 60 GHz frequency band.

In the communication method applied to access point (AP) device provided by the present disclosure, the neighbor AP device refers to a neighboring device of the AP device that sends the first message frame.

A communication method provided by an embodiment of the present disclosure may be specifically referred to FIG. 2. FIG. 2 is another schematic flowchart of the communication method provided by the embodiment of the present disclosure.

In some embodiments, the method may be applied to a STA device. The method may include the following steps.

In step S21, a first message frame is received, where the first message frame includes first identification information, and the first identification information is used to indicate that a neighbor AP device supports communicating in at least one frequency band of a 45 GHz frequency band or a 60 GHz frequency band.

The first message frame is sent by the AP device, and the neighbor AP device refers to the AP device that is a neighbor of the AP device that sent the first message frame.

The first identification information may specifically indicate, through at least one bit, that the neighbor AP device supports communicating in at least one of the 45 GHZ frequency band or the 60 GHz frequency band. The first identification information may indicate that the neighbor AP device supports communicating in both the 45 GHz frequency band and the 60 GHz frequency band by indicating “Co-located with 45 GHz/60 GHz AP”.

As an example, the first identification information may include one bit, and when the value of this bit is 1, it indicates that the neighbor AP device supports communicating in both the 45 GHz frequency band and the 60 GHz frequency band.

As an example, the first identification information may include a first bit and/or a second bit. When the value of the first bit is 1, it indicates that the neighbor AP device supports communicating in the 45 GHz frequency band. When the value of the second bit is 1, it indicates that the neighbor AP device supports communicating in the 60 GHz frequency band.

In the communication method applied to a station (STA) device provided by the present disclosure, the first message frame includes a neighbor report information element, which includes first identification information.

That is, the AP device may indicate that the neighbor AP device supports communication in at least one of the 45 GHz frequency band or the 60 GHz frequency band by sending the first message frame that includes the neighbor report information element. Specifically, this indication may be made through the first identification information in the neighbor report information element.

In the communication method applied to a station (STA) device provided by the present disclosure, the neighbor report information element includes a basic service set (BSS) identifier (ID) information field, and the basic service set identifier information field includes first identification information.

That is, the AP device may indicate that the neighbor AP device supports communication in at least one of the 45 GHz frequency band or the 60 GHz frequency band by sending the first message frame that includes the neighbor report information element. Specifically, this indication may be made through the first identification information within the Basic Service Set Identifier (BSSID) information field included in the neighbor report information element.

As an example, the first identification information may be at least one bit in the reserved bits in the basic service set identifier information field.

In the communication method applied to the station (STA) device provided by the present disclosure, the first identification information is further used to indicate that the neighbor AP device supports the ultra high reliability (UHR) capability.

When the first identification information is used to indicate that the neighbor AP device supports the UHR capability, the neighbor AP device supports communication in the sub-7 GHz frequency band.

As an example, the first message frame includes first identification information, which may be used to indicate that the neighbor AP device simultaneously supports communicating in the sub-7 GHZ, 45 GHZ, and 60 GHz frequency bands.

In the communication method applied to the station (STA) device provided by the present disclosure, the neighbor report information element includes a first information element. When the first identification information is used to indicate that the neighbor AP device supports communicating in the 45 GHz frequency band or 60 GHz frequency band, the first information element includes at least one of the following: bandwidth information, the number of spatial streams, or the modulation and coding scheme corresponding to the neighbor AP device when communicating in the 45 GHz frequency band or 60 GHz frequency band.

Specifically, when the first identification information is used to indicate that the neighbor AP device supports communicating in the 45 GHz frequency band, the first information element includes at least one of the bandwidth information, the number of spatial streams, or the modulation and coding scheme corresponding to the neighbor AP device when communicating in the 45 GHz frequency band.

As an example, the neighbor report information element includes a first information element. When the first identification information is used to indicate that the neighbor AP device supports communicating in the 45 GHz frequency band, the first information element includes the bandwidth information corresponding to the neighbor AP device when communicating in the 45 GHz frequency band.

As an example, the neighbor report information element includes a first information element. When the first identification information is used to indicate that the neighbor AP device supports communicating in the 45 GHz frequency band, the first information element includes the number of spatial streams corresponding to the neighbor AP device when communicating in the 45 GHz frequency band, such as the maximum number of spatial streams supported.

As an example, the neighbor report information element includes a first information element. When the first identification information is used to indicate that the neighbor AP device supports communicating in the 45 GHz frequency band, the first information element includes the modulation and coding scheme corresponding to the neighbor AP device when communicating in the 45 GHz frequency band.

Specifically, when the first identification information is used to indicate that the neighbor AP device supports communicating in the 60 GHz frequency band, the first information element includes at least one of the bandwidth information, the number of spatial streams, or the modulation and coding scheme corresponding to the neighbor AP device when communicating in the 60 GHz frequency band.

As an example, the neighbor report information element includes a first information element. When the first identification information is used to indicate that the neighbor AP device supports communicating in the 60 GHz frequency band, the first information element includes the bandwidth information corresponding to the neighbor AP device when communicating in the 60 GHz frequency band.

As an example, the neighbor report information element includes a first information element. When the first identification information is used to indicate that the neighbor AP device supports communicating in the 60 GHz frequency band, the first information element includes the number of spatial streams corresponding to the neighbor AP device when communicating in the 60 GHz frequency band, such as the maximum number of spatial streams supported.

As an example, the neighbor report information element includes a first information element. When the first identification information is used to indicate that the neighbor AP device supports communicating in the 60 GHz frequency band, the first information element includes the modulation and coding scheme corresponding to the neighbor AP device when communicating in the 60 GHz frequency band.

In the communication method applied to the station (STA) device provided by the present disclosure, the neighbor report information element includes a first information element. When first identification information is used to indicate that a neighbor AP device supports the ultra-high reliability (UHR) capability, the first information element includes at least one of bandwidth information or packet extension (PE) information corresponding to the neighbor AP device when communicating in the sub-7 GHz frequency band.

As an example, the neighbor report information element includes a first information element. When the first identification information is used to indicate that the neighbor AP device supports the ultra-high reliability (UHR) capability, the first information element includes the bandwidth information corresponding to the neighbor AP device communicating in the sub-7 GHz frequency band.

The bandwidth information corresponding to the communication of the neighbor AP device in the sub-7 GHz frequency band may be 640 MHz or 320 MHz+160 MHz, etc., and there is no limitation here.

As an example, the neighbor report information element includes a first information element. When the first identification information is used to indicate that the neighbor AP device supports the ultra-high reliability (UHR) capability, the first information element includes the packet extension information corresponding to the neighbor AP device when communicating in the sub-7 GHz frequency band.

In some embodiments, when the first identification information is used to indicate that the neighbor AP device supports the ultra high reliability (UHR) capability, the first information element may further include at least one of the number of spatial streams or the modulation and coding scheme corresponding to the neighbor AP device when communicating in the sub-7 GHz frequency band.

In the communication method applied to a station (STA) device provided by the present disclosure, when the neighbor report information element includes a first information element, the first information element is at least one of a capability information element (Capabilities Element) or an operational information element (Operational element).

The content of the first information element is the same as the content of the capability information element or the operation information element in a beacon frame or a probe response frame sent by the AP device in the same basic service set.

In the communication method for the station (STA) device provided by the present disclosure, the neighbor report information element further indicates, through other identification information, that the neighbor AP device supports communicating in the 5 GHz frequency band and/or 6 GHz frequency band.

As an example, the neighbor report information element includes second identification information and third identification information. When the values of the second identification information and third identification information are 1, it indicates that the neighbor AP device supports communicating in both the 5 GHz frequency band and the 6 GHZ frequency band.

As an example, when the values of the first identification information, second identification information, and third identification information are 1, it indicates that the neighbor AP device simultaneously supports communicating in the 5 GHz frequency band, 6 GHz frequency band, 45 GHz frequency band, and 60 GHz frequency band.

In the communication method applied to a station (STA) device provided by the present disclosure, the first message frame is a neighbor report request frame.

As an example, the STA device receives a neighbor report request frame sent by the AP device. The neighbor report request frame includes first identification information, which is used to indicate that the neighbor AP device supports communicating in at least one of the 45 GHz frequency band or the 60 GHz frequency band.

In some embodiments, the neighbor report request frame includes a neighbor report information element, which includes first identification information. The first identification information is used to indicate that the neighbor AP device supports communicating in at least one of the 45 GHz frequency band or the 60 GHz frequency band.

In the embodiments of the present disclosure, the AP device may indicate through the first identification information in the first message frame that the neighbor AP device supports communicating in the 45 GHz frequency band and/or 60 GHz frequency band. The AP device may also indicate through the first identification information that the neighbor AP device supports the UHR capability. At the same time, the first information element may be used to indicate the bandwidth information and other parameters of the corresponding frequency band when the neighbor AP device supports communicating in that band.

As shown in FIG. 3, an embodiment of the present disclosure provides a communication apparatus, which includes:
a determining unit 31, configured to determine a first message frame, where the first message frame includes first identification information, and the first identification information is used to indicate that a neighbor AP device supports communicating in at least one frequency band of a 45 GHz frequency band or a 60 GHz frequency band; and
a sending unit 32, configured to send the above first message frame.

Additionally, in an embodiment of the present disclosure, the above first message frame includes a neighbor report information element, and the above neighbor report information element includes the above first identification information.

Additionally, in an embodiment of the present disclosure, the above neighbor report information element includes a first information element, and when the above first identification information is used to indicate that the above neighbor AP device supports communicating in the 45 GHz frequency band or the 60 GHz frequency band, the first information element includes at least one of bandwidth information, a number of spatial streams, or a modulation and coding scheme corresponding to the above neighbor AP device when the above neighbor AP device communicates in the 45 GHz frequency band or the 60 GHz frequency band.

Additionally, in an embodiment of the present disclosure, the above neighbor report information element includes a basic service set identifier information field, and the above basic service set identifier information field includes the above first identification information.

Additionally, in an embodiment of the present disclosure, the above first identification information is further used to indicate that the neighbor AP device supports an ultra high reliability (UHR) capability.

Additionally, in an embodiment of the present disclosure, when the above first identification information is used to indicate that the neighbor AP device supports UHR capability, the neighbor AP device supports communicating in a sub-7 GHz frequency band.

Additionally, in an embodiment of the present disclosure, the above neighbor report information element includes a first information element, and when the above first identification information is used to indicate that the above neighbor AP device supports the UHR capability, the above first information element includes at least one of bandwidth information or packet extension information corresponding to the above neighbor AP device when communicating in the sub-7 GHz frequency band.

Additionally, in an embodiment of the present disclosure, the above first information element is a capability information element or an operation information element.

Additionally, in an embodiment of the present disclosure, the above first message frame is a neighbor report request frame.

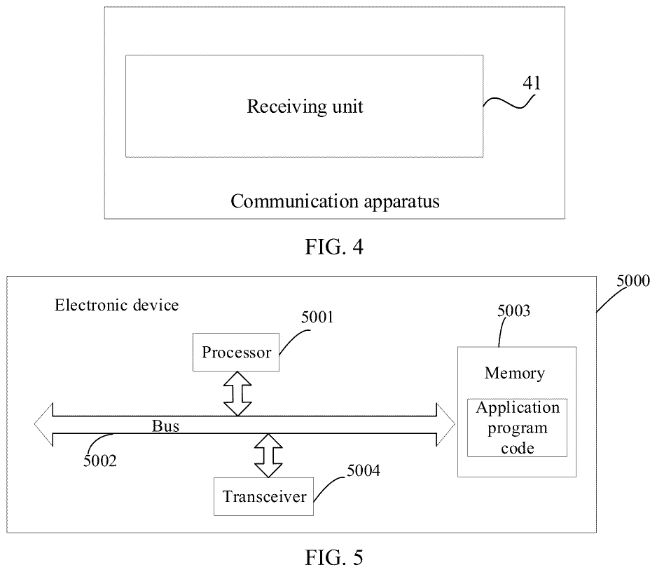

As shown in FIG. 4, an embodiment of the present disclosure provides a communication apparatus, which includes:
a receiving unit 41, configured to receive a first message frame, where the first message frame includes first identification information, and the first identification information is used to indicate that a neighbor AP device supports communicating in at least one frequency band of a 45 GHz frequency band or a 60 GHz frequency band.

Additionally, in an embodiment of the present disclosure, the above first message frame includes a neighbor report information element, and the above neighbor report information element includes the above first identification information.

Additionally, in an embodiment of the present disclosure, the above neighbor report information element includes a first information element. When the above first identification information is used to indicate that the above neighbor AP device supports communicating in the 45 GHz frequency band or the 60 GHz frequency band, the first information element includes at least one of bandwidth information, a number of spatial streams, or a modulation and coding scheme corresponding to the above neighbor AP device when the above neighbor AP device communicates in the 45 GHz frequency band or the 60 GHz frequency band.

Additionally, in an embodiment of the present disclosure, the above neighbor report information element includes a basic service set identifier information field, and the above basic service set identifier information field includes the above first identification information.

Additionally, in an embodiment of the present disclosure, the above first identification information is further used to indicate that the neighbor AP device supports an ultra high reliability (UHR) capability.

Additionally, in an embodiment of the present disclosure, when the above first identification information is used to indicate that the neighbor AP device supports the UHR capability, the neighbor AP device supports communicating in a sub-7 GHz frequency band.

Additionally, in an embodiment of the present disclosure, the above neighbor report information element includes a first information element, and when the above first identification information is used to indicate that the above neighbor AP device supports the UHR capability, the above first information element includes at least one of bandwidth information or packet extension information corresponding to the above neighbor AP device when the above neighbor AP device communicates in the sub-7 GHz frequency band.

Additionally, in an embodiment of the present disclosure, the above first information element is a capability information element or an operation information element.

Additionally, in an embodiment of the present disclosure, the above first message frame is a neighbor report request frame.

An embodiment of the present disclosure further provides an electronic device, as shown in FIG. 5. The electronic device 5000 shown in FIG. 5 includes a processor 5001 and a memory 5003. The processor 5001 and the memory 5003 are connected, for example, via a bus 5002. In some embodiments, the electronic device 5000 may further include a transceiver 5004. It should be noted that in practical applications, the number of the transceiver 5004 is not limited to one, and the structure of the electronic device 5000 does not constitute a limitation of the embodiments of the present disclosure.

The memory 5003 is used to store the application program code for executing the embodiments of the present disclosures, and the execution of the application program code is controlled by the processor 5001. When the electronic device 5000 functions as an AP device, the processor 5001 executes the application program code stored in the memory 5003 to implement the communication method applicable to the AP device in this solution. When the electronic device 5000 functions as an STA device, the processor 5001 executes the application program code stored in the memory 5003 to implement the communication method applicable to the STA device in this solution.

The bus 5002 may include a path for transmitting information between the above components. The bus 5002 may be a Peripheral Component Interconnect (PCI) bus or an Extended Industry Standard Architecture (EISA) bus, or the like. The bus 5002 may be divided into an address bus, a data bus, a control bus, etc. For ease of representation, only one thick line is used in FIG. 5 for indicating the bus, but it does not indicate that there is only one bus or only one type of bus.

The memory 5003 may be a Read Only Memory (ROM) or other types of static storage devices that may store static information and instructions, a Random Access Memory (RAM) or other types of dynamic storage devices that may store information and instructions, or an Electrically Erasable Programmable Read Only Memory (EEPROM), a Compact Disc Read Only Memory (CD-ROM) or other optical disk storage, optical disc storage (including compact optical disc, laser disc, optical disc, digital versatile optical disc, Blu-ray disc, etc.), a magnetic disk storage medium or other magnetic storage device, or any other medium that may be used to carry or store desired program code in the form of instructions or data structures and may be accessed by a computer, but is not limited thereto.

An embodiment of the present disclosure provides a computer-readable storage medium on which a computer program is stored, when being run on a computer, causes the computer to execute the corresponding contents in the above method embodiments.

It should be understood that, although the steps in the flowcharts of the accompanying drawings are shown in sequence as indicated by the arrows, these steps are not necessarily performed sequentially in the order as indicated by the arrows. There is no strict restriction on the performing order of these steps, and they may be performed in other orders, unless otherwise stated herein. Moreover, at least a part of the steps in the flowcharts of the accompanying drawings may include multiple sub-steps or multiple stages, and these sub-steps or stages are not necessarily completed at the same time, but may be performed at different times, and the performing order thereof is not necessarily sequential, but may be performed in turn or alternately with other steps or at least a part of the sub-steps or stages of other steps.

It should be noted that the computer-readable medium mentioned above in the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but is not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, apparatus or device. In the present disclosure, the computer-readable signal medium may include a data signal propagated in a baseband or as part of a carrier wave, which carries computer-readable program code. The propagated data signal may take a variety of forms, including but not limited to electromagnetic signals, optical signals, or any suitable combination of the above. The computer readable signal medium may also be any computer readable medium other than the computer readable storage medium, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The above computer-readable storage medium may be included in the above AP device or STA device, or may exist independently without being assembled into the AP device or the STA device.

The above computer-readable storage medium carries one or more programs which, when being executed by the AP device or the STA device, cause the AP device or the STA device to perform the corresponding communication method.

According to an aspect of the present disclosure, a computer program product or a computer program is provided, the computer program product or the computer program includes computer instructions, and the computer instructions are stored in a computer-readable storage medium. A processor of a computer device reads the computer instructions from the computer-readable storage medium, and the processor executes the computer instructions, to cause the computer device to perform the methods provided in the above various optional implementations.

The computer program code for performing the operations of the present disclosure may be written in one or more programming languages, or a combination thereof, including object-oriented programming languages, such as Java, Smalltalk, C++, and conventional procedural programming languages, such as “C” language or similar programming languages. The program code may be executed entirely on the user's computer, partially executed on the user's computer, executed as a separate software package, executed partially on the user's computer and partially on a remote computer, or executed entirely on a remote computer or server. In the cases involving a remote computer, the remote computer may be connected to the user's computer through any type of network, including a local area network (LAN) or a wide area network (WAN), or may be connected to an external computer (e.g., via Internet using an Internet service provider).

The flow charts and block diagrams in the accompanying drawings illustrate the possible architectures, functions and operations of the system, method and computer program product according to various embodiments of the present disclosure. In this regard, each of the blocks in the flow charts or block diagrams may represent a module, a program segment or part of code, and the module, the program segment or the part of code contains one or more executable instructions for realizing the specified logical functions. It should also be noted that in some alternative implementations, the functions marked in the blocks may also occur in a sequence different from that marked in the accompanying drawings. For example, two blocks shown in succession may actually be executed substantially in parallel, or they may sometimes be executed in the opposite order, depending on the functions involved. It should also be noted that each block in the block diagrams and/or flow charts, and the combination of the blocks in the block diagrams and/or flow charts may be implemented with a dedicated hardware-based system that performs a specified function or operation, or may be implemented with a combination of dedicated hardware and computer instructions.

The modules involved in the embodiments described in the present disclosure may be implemented in software or in hardware. The names of the modules do not make limitation on the modules themselves in some cases. For example, a module A may also be described as “a module A for performing operation B”.

Those described above are only explanations of preferred embodiments of the present disclosure and the technical principles employed. Those skilled in the art should understand that the scope of disclosure involved in the present disclosure is not limited to the technical solutions formed by the above specific combination of the technical features, but should also cover other technical solutions formed by any combination of the above technical features or their equivalent features without departing from the above disclosed concept, for example, a technical solution formed by replacing the above features with the technical features with similar functions disclosed in the present disclosure (but not limited to).

1. A communication method, applied to an access point (AP) device, comprising:
determining a first message frame, wherein the first message frame comprises first identification information, and the first identification information indicates that a neighbor AP device supports communicating in at least one frequency band of a 45 GHZ frequency band or a 60 GHz frequency band; and
sending the first message frame.

2. The method according to claim 1, wherein the first message frame comprises a neighbor report information element, and the neighbor report information element comprises the first identification information.

3. The method according to claim 2, wherein the neighbor report information element comprises a first information element, and in response to that the first identification information indicates that the neighbor AP device supports communicating in the 45 GHz frequency band or the 60 GHz frequency band, the first information element comprises at least one of bandwidth information, a number of spatial streams, or a modulation and coding scheme corresponding to the neighbor AP device when the neighbor AP device communicates in the 45 GHz frequency band or the 60 GHz frequency band.

4. The method according to claim 2, wherein the neighbor report information element comprises a basic service set identifier information field, and the basic service set identifier information field comprises the first identification information.

5. The method according to claim 2, wherein the first identification information further indicates that the neighbor AP device supports an ultra high reliability (UHR) capability.

6. The method according to claim 5, wherein in response to that the first identification information indicates that the neighbor AP device supports the UHR capability, the neighbor AP device supports communicating in a sub-7 GHz frequency band.

7. The method according to claim 5, wherein the neighbor report information element comprises a first information element, and in response to that the first identification information indicates that the neighbor AP device supports the UHR capability, the first information element comprises at least one of bandwidth information or packet extension information corresponding to the neighbor AP device when the neighbor AP device communicates in a sub-7 GHz frequency band.

8. The method according to claim 3, wherein the first information element is a capability information element or an operation information element.

9. The method according to claim 1, wherein the first message frame is a neighbor report request frame.

10. A communication method, applied to a station (STA) device, comprising:
receiving a first message frame, wherein the first message frame comprises first identification information, and the first identification information indicates that a neighbor AP device supports communicating in at least one frequency band of a 45 GHZ frequency band or a 60 GHz frequency band.

11. The method according to claim 10, wherein the first message frame comprises a neighbor report information element, and the neighbor report information element comprises the first identification information.

12. The method according to claim 11, wherein the neighbor report information element comprises a first information element, and in response to that the first identification information indicates that the neighbor AP device supports communicating in the 45 GHz frequency band or the 60 GHz frequency band, the first information element comprises at least one of bandwidth information, a number of spatial streams, or a modulation and coding scheme corresponding to the neighbor AP device when the neighbor AP device communicates in the 45 GHz frequency band or the 60 GHz frequency band.

13. The method according to claim 11, wherein the neighbor report information element comprises a basic service set identifier information field, and the basic service set identifier information field comprises the first identification information.

14. The method according to claim 11, wherein the first identification information further indicates that the neighbor AP device supports an ultra high reliability (UHR) capability.

15. The method according to claim 14, wherein in response to that the first identification information indicates that the neighbor AP device supports the UHR capability, the neighbor AP device supports communicating in a sub-7 GHz frequency band.

16. The method according to claim 14, wherein the neighbor report information element comprises a first information element, and in response to that the first identification information indicates that the neighbor AP device supports the UHR capability, the first information element comprises at least one of bandwidth information or packet extension information corresponding to the neighbor AP device when the neighbor AP device communicates in a sub-7 GHz frequency band.

17. The method according to claim 12, wherein the first information element is a capability information element or an operation information element.

18. The method according to claim 10, wherein the first message frame is a neighbor report request frame.

19.-20. (canceled)

21. An access point (AP) device, wherein the AP device comprises a memory, a processor, and a computer program stored on the memory and executable on the processor, and the processor, when executing the program, implements:
determining a first message frame, wherein the first message frame comprises first identification information, and the first identification information indicates that a neighbor AP device supports communicating in at least one frequency band of a 45 GHZ frequency band or a 60 GHz frequency band; and
sending the first message frame.

22. A station (STA) device, wherein the STA device comprises a memory, a processor, and a computer program stored on the memory and executable on the processor, and the processor, when executing the program, implements the method according to claim 10.

23. (canceled)
